(19) United States
(12) Patent Application Publication
(10) Pub. No.: US 2004/0151862 A1
(43) Pub. Date: Aug. 5, 2004

(54) Clustering means and methods and security label thereof

(76) Inventors: Rami Molcho, Montville, NJ (US); Eli Feder, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/735,637

(22) Filed: Dec. 16, 2003

Related U.S. Application Data
(60) Provisional application No. 60/437,607, filed on Jan. 2, 2003.

(30) Foreign Application Priority Data
Dec. 16, 2002 (IL) 153483

(51) Int. Cl. B32B 31/00; B32B 7/00

(52) U.S. Cl. 428/41.7; 156/268; 156/247

(57) ABSTRACT

The present invention relates to clustering means for clustering of plurality of items substantially similar to each other so that a single item may individually be detached from the cluster without unstitching the rest of the cluster. The present invention relates also to a multi-ply label structure for obscuring and maintaining the integrity of indicia printed on a product. The present invention also relates to a method of producing a multi-ply label structure for use in obscuring and maintaining the integrity of indicia printed on a substrate.

### RELATED APPLICATIONS

This application claims the benefit of U.S. provisional application No. 60/437,607 filed on Jan. 2, 2003 and of Israeli patent application No. 153483 filed on Dec. 16, 2002.

### FIELD OF THE INVENTION

The present invention relates to an apparatus and method for clustering plurality of packages with a wrap allowing unclustering one package from the plurality of clustered packages without violating the remaining cluster. The present invention relates also to multi-ply security label structure for obscuring and maintaining the integrity of indicia printed on a substrate. The present invention also relates to a method of producing a multi-ply label structure for use in obscuring and maintaining the integrity of indicia printed on a substrate.

### BACKGROUND OF THE INVENTION

There exist various means and methods for clustering plurality of packages together by a wrapping sheet so that the wrapping sheet may be torn or otherwise be peeled off while reaching onto at least one package in the cluster. Yet, with all existing means and methods once the wrapping sheet is opened for even one package, all other packages become apart. This includes for example club pack and multiple pack products. It is not limited to cosmetic, food and industrial products. There exist also various products, which require the concealment of printed indicia until a consumer purchases the product. Such products include, but are not limited to, lottery tickets, admission tickets, and telephone cards. The indicia to be concealed on such products includes, but is not limited to, coupons, personal identification numbers (PINs), prizes, and promotional messages. To maintain the integrity of such indicia, e.g. lottery characters or PINs, a security label or tape adhered to the product covers such information.

The disadvantages of current security labels are well known in the art. Security labels, such as those described above, have a great risk of potentially critical failures which can render products useless to the end user, or consumer. For example, the printing ink on scratch-off labels may not function at all or as cleanly as necessary. This occurs when the end user, or consumer, is unable to scratch off the printing ink to expose the underlying data or images. Likewise, security labels which have an ungummed void or deadened area cannot ensure a straight tear through the intended area in order to expose the concealed data or images.

### BRIEF DESCRIPTION OF THE DRAWINGS

In the drawing figures, which are not to scale, and which are merely illustrative and wherein like reference characters denote similar elements throughout the several views:

FIG. 1A is a schematic illustration of a clustering means according to an embodiment of the invention;

FIGS. 1B and 1C are schematic illustrations of two layers of a clustering means according to some embodiments of the invention;

FIGS. 2A, 2B and 2C are isometric illustrations of clustered items according to some embodiments of the invention;

FIG. 3 is a plane view of a multi-ply label concealing indicia according to some embodiments of the present invention;

FIG. 4 is a plane view of the multi-ply label of FIG. 3 with the tear-off portion of the label partially removed according to some embodiments of the present invention;

FIG. 5 is a sectional view taken along line 5-5 of FIG. 3;

FIG. 6 is a flow diagram illustrating method of production of a clustering means according to some embodiments of the present invention; and

FIG. 7 is a flow diagram illustrating method of use of a clustering means according to some embodiments of the present invention.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

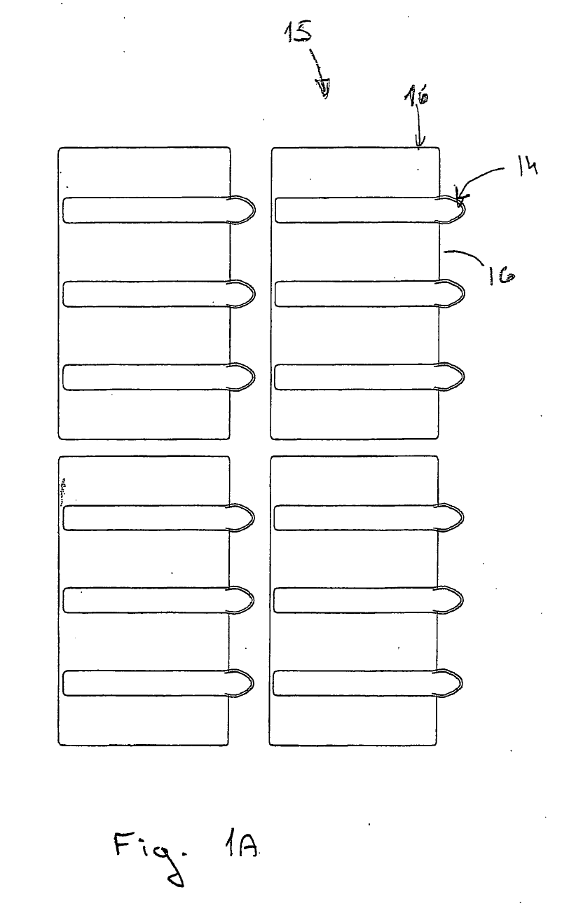

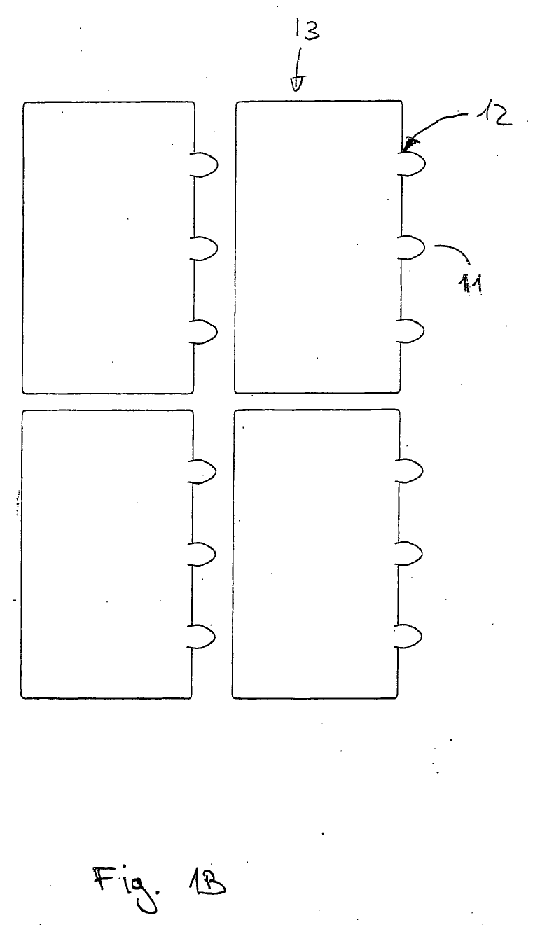

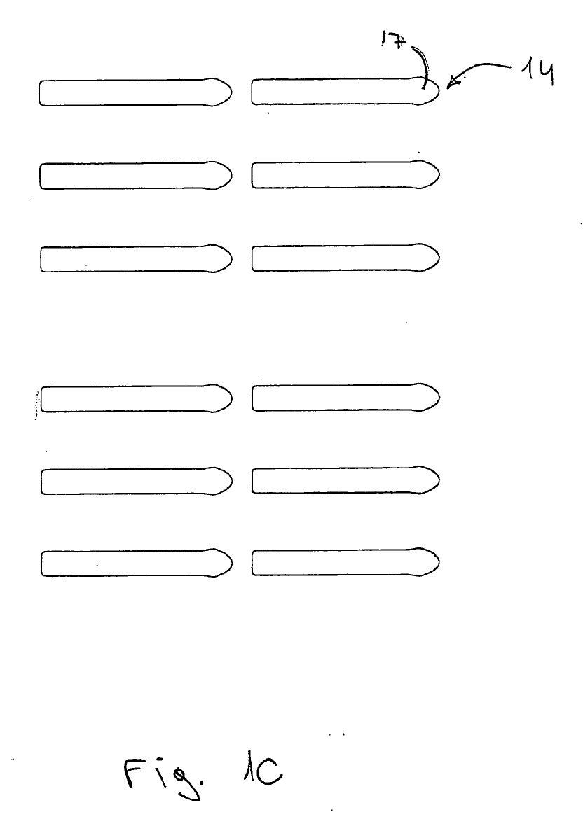

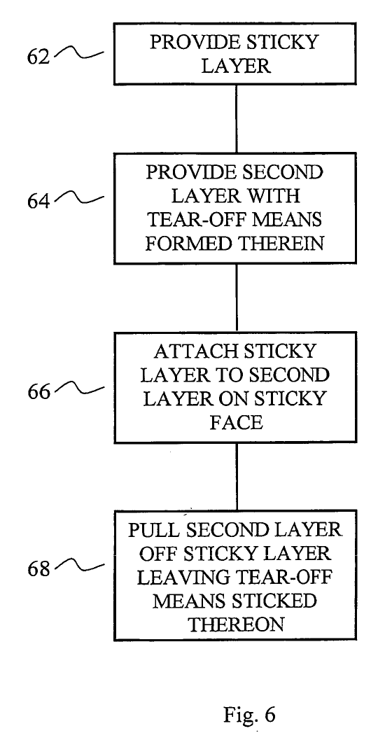

A clustering means is provided for clustering of plurality of items substantially similar to each other so that a single item may individually be removed from the cluster without unstitching the rest of the cluster. Reference is made now to FIGS. 1A, 1B and 1C and to FIG. 6. FIG. 1A illustrates some embodiments of clustering means 10. FIG. 1B illustrates a sticky layer 13 being a component of clustering means 10. FIG. 1C illustrates a tear-off means 14 of clustering means 10. FIG. 6 is a flow diagram illustrating method of production of a clustering means 10 according to some embodiments of the present invention. Clustering means 10 may comprise of layer 13 (block 62), having at least one sticky face. Pulling tab 11 may be formed along at least one end of layer 13 and weakening points 12 may be made, for example in the form of short cuts made at both sides of pulling tab 11. A second layer 15 may comprise tear-off means 14 formed by means of die-cut or the like, substantially across layer 15 and having pulling end 17 formed at at least one end of tear-off means 14. Layer 15 may be attached to the sticky face of layer 13 (blocks 64, 66). Tear-off means 14 may have the form and be positioned so that its pulling end 17 substantially covers a corresponding pulling tab 11 in sticky layer 13, as shown in FIG. 1A.

When layer 13 is attached layer 15 the residual area around tear-off means 14, generally designated 16, may be peeled of layer 13 (block 68), leaving its sticky face free and available except for the area covered by tear-off means 14.

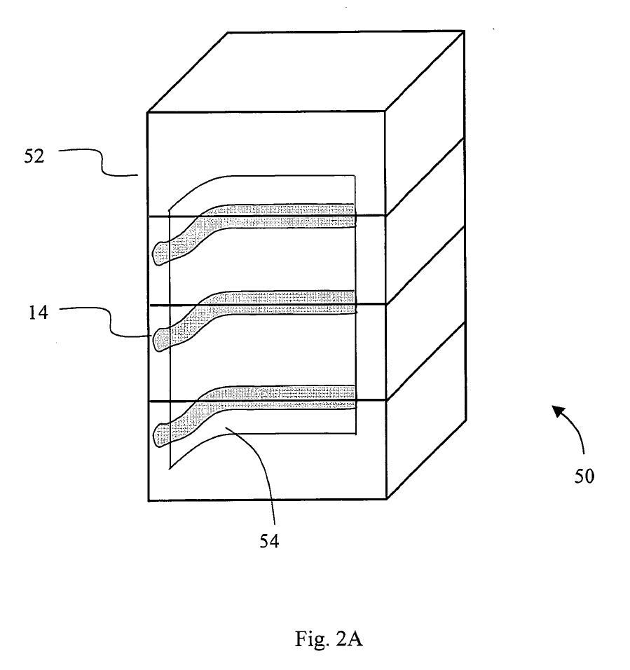

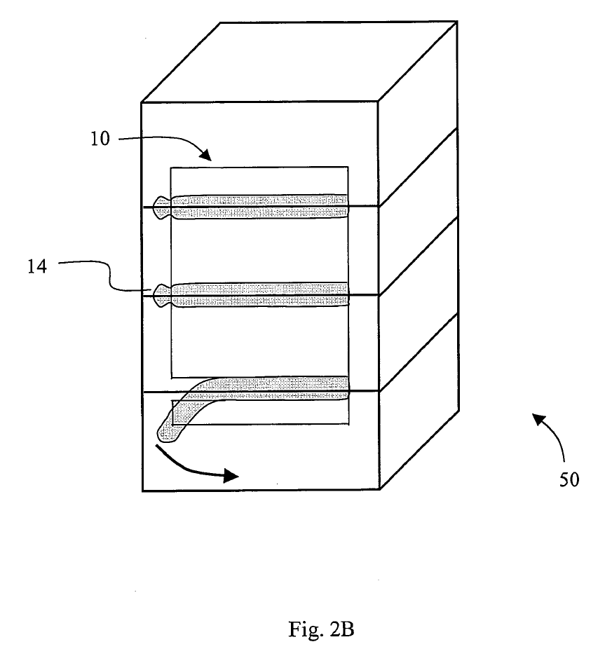

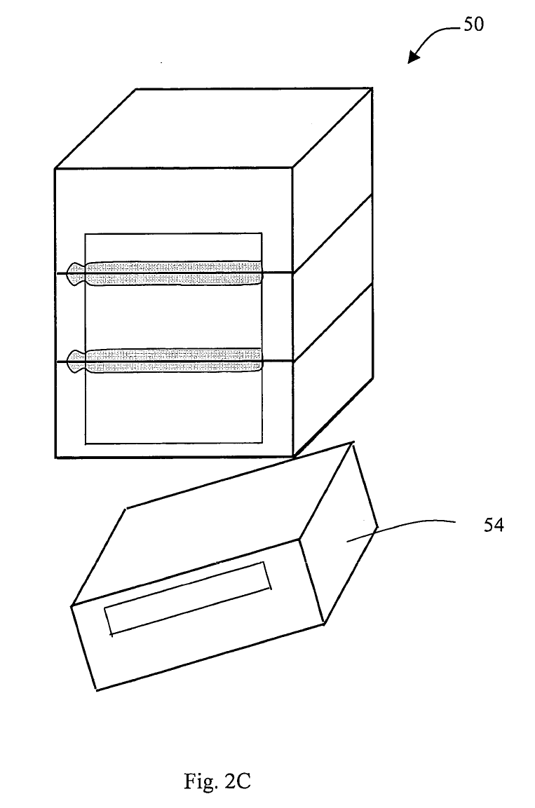

According to some embodiments of the present invention the pitch between each two adjacent tear-off means 14 in clustering means 10 may be made substantially equal to the pitch of clustered items, so that when clustering means 10 is applied onto a cluster of items, each tear-off means 14 is placed against the touch-line of two consequent clustered items as shown in FIG. 2B. Clustering means 10 may be applied by means of hand sticking, automatic sticking process and the like. Thus, clustering means 10 may be stored and provided carried on a carrying layer (not shown) such as a rolled silicon coated layer, from which it may be peeled prior to being applied onto a cluster of items.

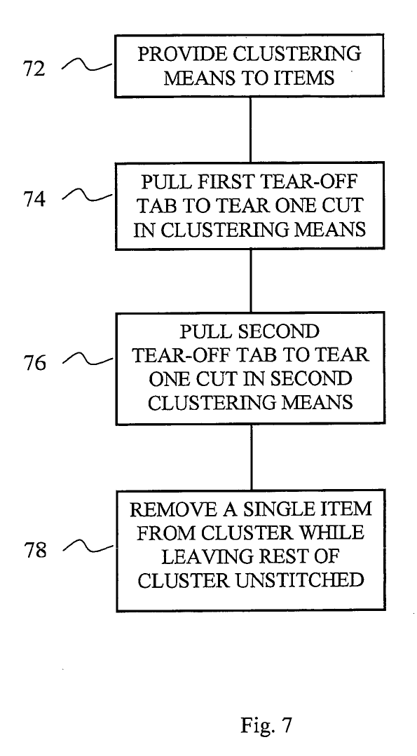

Reference is made now to FIGS. 2A, 2B and 2C, which are isometric illustrations of clustered items according to an embodiment of the invention and to FIG. 7, which is a flow diagram illustrating method of use of a clustering means according to some embodiments of the present invention. Except for the places where tear-off means 14 is placed on the at least one sticky face of sticky layer 13, rest of the sticky face of layer 13 is ready to be adhered onto at least one side of to be clustered items. Clusterable items 52 may be held together by applying clustering means 10 to at least one face of items 52, so that tear-off means 14 are placed against touching edges of two consequent clustered items 52 (block 72). Once clustering means 10 is attached to items 52 as shown in FIG. 2A, items 52 are clustered.

When one clustered item 52 is to be individually separated from the cluster, tear-off means 14 may be pulled (blocks 74, 76) as illustrated in FIG. 2B, in order to tear clustering sticker 10 along a desired line. Item 54 then may be separated from cluster 50 (block 78).

Tear-off means 14 may be made of a material that allows pulling it from a first end formed as pulling end 17, said first end may be loose so that when it is pulled it may tear sticky layer 13, presumably starting from weakening points 12 along substantially straight lines across sticky layer 13 as shown in FIG. 2B.

According to some embodiments of the present invention, a sticker may be used also to securely and temper-proofed conceal codes such as numbers, characters or other graphical signs. Such codes, such as raffle numbers, PIN number and the like, that need to be concealed may be printed or otherwise implemented on an inner (hidden) face of either tear-off means, or on an inner face of an item on which a sticker of the present invention may be applied. Such sticker may be positioned on said item so that tear-off means is placed to cover said code. Thus, when said tear-off means is pulled said concealed code is made visible. This code may be used in the arrangement of any kind of promotion campaign for the products packed in said item, or for providing a secured number (such as an activation code for a calling card), or for any other campaign taking the advantage of a hidden code.

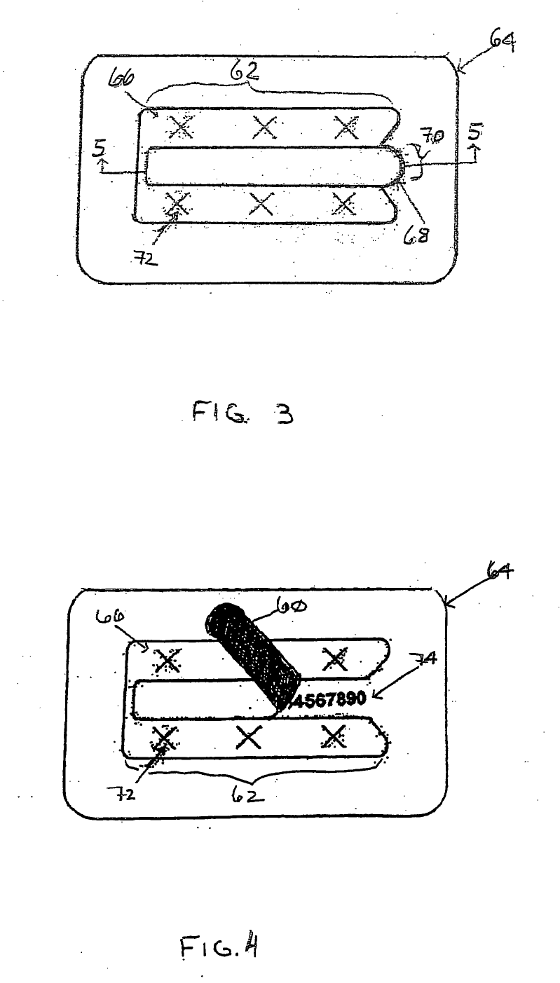

In accordance with some embodiments of the present invention, there is provided a multi-ply label. Reference is made to FIG. 3, which is a plane view of a multi-ply label 62 affixed to a substrate such as a telephone card with indicia requiring concealment according to some embodiments of the present invention. Multi-ply label 62 is constructed in accordance with some aspects of the present invention. Specifically, multi-ply label 62 is affixed to an item, such as telephone card, generally indicated as 64, with indicia requiring concealment or to a cluster of items, such as 50 of FIGS. 2A-2C.

Multi-ply label 62 may include a top-ply generally indicated as 66, and a bottom-ply generally indicated as 68. Top-ply 66 may be made of polypropylene, or any other such material known in the art, or paper, or metallized paper. Top-ply 66 may include any one of various adhesive coatings on the bottom side of Top-ply 66. Bottom-ply 68 may be made of polyester, or any other such material known in the art such as a film, paper, or film-paper combination.

Generally, bottom-ply 68 may be designed to hold top-ply 66 in place and to protect a top-ply 66 from adhering to an unintended substrate prior to dispensing and intended use. According to some embodiments of the present invention, bottom-ply 68 may provide a second ply of multi-ply label 62 structure when adhered to a substrate 4, such as telephone card. Bottom-ply 68 may be precut along cutting line outlining a portion in bottom-ply 68 (not shown) corresponding in shape and position to tear-off means 70 in top-ply 66. By this construction, a portion of bottom-ply 68 may remain in contact with the adhesive coating of top-ply 66 upon peeling of the remaining portion of bottom-ply 68 from top-ply 66, for example when applying onto substrate 64. This multi-ply portion, generally indicated as 70, creates the functional portion of label 62. Thus, label 62 may be affixed to substrate 64 so that multi-ply portion 70 is positioned directly over the indicia to be concealed and, as described in more detail below, can be easily detached from label 62 and cleanly removed from substrate 64 to expose the underlying indicia.

As seen in FIG. 3, in some embodiments, top-ply 66 is die cut in a special shape which allows for an easy peel area located on the center edge of label 62. Top-ply 66 may include additional cuts, such as “X” cuts, generally indicated as 72, which prevent the removal of label 62 from substrate 64. Specifically, by addition of the “X” cuts to the top-ply 66, any effort at removing portions of label 66 other than portion 70 will cause an inevitable and obvious damage to top-ply 66.

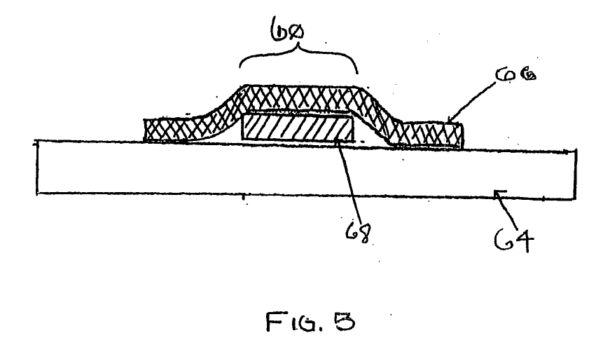

Reference is made now to FIG. 4, which is a plane view of multi-ply label 62 of FIG. 1 with multi-ply portion 70 of the label partially removed, according to some embodiments of the present invention. Multi-ply portion 10 is shown partially peeled away so as to expose a PIN, generally indicated as 74. As seen in FIG. 4, portions of top-ply 66 remain adhered to the surface of substrate 64 while multi-ply portion 70 is peeled away substrate 64.

FIG. 5 depicts a sectional view taken along line 5-5 of FIG. 3. As seen in FIG. 3, bottom-ply 68 remains in contact with an area of top-ply 66 to create multi-ply portion 70. Multi-ply portion 70 because it does not include an adhesive undercoating is placed directly over the indicia to be concealed on telephone card 4. The remaining areas of top-ply 66, which are not in contact with bottom-ply 68, adhere to substrate 64.

Some embodiments of the present invention create a more user-friendly and tamper-proof security label. Specifically, a security label of the present invention may include no chemical functional flaws such as those associated with the security labels of prior art. The security label of the present invention is easy to use and is virtually failure-proof. The end user, or consumer, can simply grab the end of the multi-ply portion 68 in the FIGS. above, and pull the portion from one side of the security label to the other thereby exposing the concealed indicia.

The security label of the present invention also provides a greater resistance to tampering and evidence of tampering. The security label of the present invention cannot be removed using common adhesive tape, such as is the case with scratch-off labels of the prior art.

Additionally, because the security label of the present invention is designed with no face cuts, or additional security cuts (shown as “X” cuts in FIG. 3), in the multi-ply portion of the security label any tampering of the label is evident.

In accordance with some embodiments of the present invention, there is provided a method for producing a multiply security label. The multi-ply material, which includes a face stock and base liner as described above, undergoes a special die cutting process. Prior to the die cutting process, the multi-ply material can be rotary printed and over-varnished as needed.

The multi-ply material is first die cut from above the face stock, described above, either using a single die station and one or two cutting dies or a dual die station and two cutting dies. The first die cutting makes the final label shape or design and can include additional security cuts, such as “X” cuts, which prevent the removal of the label from an intended substrate. The second die cutting cuts from beneath the base liner and cuts a specific area and shape in the base liner only.

Specifically, the face stock die template can include the outer die cut, which creates the shape or design of the label, and the inner die cut, which creates the additional security cuts, such as “X” cuts, on the face stock layer (shown in FIGS. 1 and 2) of the multi-ply material. The base liner die template cuts a specific area and shape in the base liner only. This die cut overlaps the first die cut, created by face stock die template, by as much as needed to ensure that the die cuts function together as required.

Upon completion of the two die cuttings, the waste material of the face stock, i.e., the material surrounding the die cut image created by the face stock die template, is removed. The material remaining includes that area of the face stock created by face stock die template and base liner, including the special area created by base liner die template. This remaining material creates a security label (shown in FIG. 1) secured to a base liner. The labels are wound into rolls and can be applied to the intended substrate by hand or through automatic label application machinery.

While there have been shown and described and pointed out novel features of the present invention as applied to embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall there between. In particular, this invention should not be construed as being limited to the dimensions, proportions or arrangements disclosed herein.

What is claimed is:

1. A clustering means comprising:
a first layer having at least one sticky face;
a second layer having at least one tear-off means formed as an elongated tape;
said second layer is attached to said first layer on its at least one sticky face.

2. The clustering means of claim 1, wherein said first layer further comprising at least one pulling tab formed along one side of said first layer and weakening cuts formed on both sides of said pulling tab.

3. A method comprising:
providing a first layer, said layer having at least one sticky face;
providing a second layer, said second layer comprising at least one tear-off means formed therein;
attaching said first and said second layers; and
removing from said first layer all residual parts of said second layer around said tear-off means.

4. A method comprising:
applying a clustering means having sticky areas and tear-off means to a plurality of substantially equal items so that sticky areas of said clustering means are adhered to side face of said items and tear-off means is placed along touch-line of two adjacent items of said plurality of items.

5. The method of claim 4, further comprising:
pulling said tear-off means so as to tear across said clustering means; and
dividing said plurality of items into two groups, each group is remaining clustered.

6. A method comprising:
pulling tear-off means off a clustering means adhered on a plurality of items so as to tear across said clustering means; and
dividing said plurality of items into two groups, each group is remaining clustered.

7. A multi-ply label structure for obscuring and maintaining the integrity of indicia printed on a substrate, comprising:
a top ply having a top surface for receiving printed matter and a pressure sensitive adhesive bottom surface for adhering to said substrate; and
a bottom ply connected to an area of said pressure sensitive adhesive bottom surface of said face stock thereby providing a clean non-pressure sensitive area which will not adhere to said indicia on said substrate.

8. A method for producing a multi-ply label structure including the steps of:
providing a multi-layer material having a top ply with an adhesive under coating and a bottom ply;
cutting a first pattern or design into said top ply of said multi-layer material;
cutting a second pattern or design into said bottom ply of said multi-layer material so that said second pattern overlaps said first pattern; and
removing portions of said top ply which were not included in said cutting a first pattern, thereby a multi-ply label structure remains.
